(19) United States
(12) Patent Application Publication
(10) Pub. No.: US 2009/0182595 A1
(43) Pub. Date: Jul. 16, 2009

(54) Operational Transformation for Analyzing Business Processes

(76) Inventor: John J. Milaski, Cape Coral, FL (US)

Correspondence Address: DILLON & YUDELL LLP, 8911 N. CAPITAL OF TEXAS HWY.,, SUITE 2110, AUSTIN, TX, 78759, US

(21) Appl. No.: 12/014,439

(22) Filed: Jan. 15, 2008

(51) Int. Cl. G06Q 10/00

(52) U.S. Cl. 705/7

(57) ABSTRACT

An operational level process diagram depicts the execution linkage between a process, organization and technology at the operational level. Business objectives, issues, and requirements are effectively linked to technology and organization through critical process elements, thus providing a perspective that ensures an effective transformation of process, organization, and technology.

### BACKGROUND OF THE INVENTION

1. Technical Field

The present disclosure relates in general to the field of computers, and more particularly to the use of computer software. Still more particularly, the present disclosure relates to analyzing business processes.

2. Description of the Related Art

Work sequencing, collaboration, and synchronization of integrated business process participants are complex. Current linear process decomposition techniques do not describe the true nature of such collaborative activities. Operational process reengineering requires redesign at the individual execution level where the linkage occurs between process, organization, and technology. Functional (linear) decomposition techniques model major business processes by activity hierarchies without horizontal task synchronization at the operational execution level. Activity descriptions only show individual task detail, without relationship to tasks in other departments.

### SUMMARY OF THE INVENTION

An operational level process diagram depicts the execution linkage between a process, organization and technology at the operational level. Business objectives, issues, and requirements are effectively linked to technology and organization through critical process elements, thus providing a perspective that ensures an effective transformation of process, organization (e.g., role changes, job design, performance measures), and technology (e.g., requirements, multiple package implications, application integration, business process interlinkage, scenario validation).

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 illustrates an exemplary computer in which the present invention may be utilized;

FIGS. 2-5 depict an exemplary operational-level process diagram;

FIGS. 6A-B illustrate exemplary data flows associated with the operational-level process diagram depicted in FIGS. 2-5;

FIG. 7 depicts an exemplary data model associated with the operational-level process diagram depicted in FIGS. 2-5;

FIG. 8 illustrates an exemplary system diagram associated with the operational-level process diagram depicted in FIGS. 2-5;

FIG. 9 is an organization chart of actors represented in the operational-level process diagram depicted in FIGS. 2-5;

FIG. 10 is a high-level flow-chart of steps taken to create and utilize an operational-level process diagram;

FIGS. 11A-B are flow-charts showing steps taken to deploy software capable of executing the steps and processes described in FIGS. 2-10; and

FIGS. 12A-B are flow-charts showing steps taken to execute the steps and processes shown in FIGS. 2-10 using an on-demand service provider;

### DETAILED DESCRIPTION OF THE PREFERRED EMBODIMENT

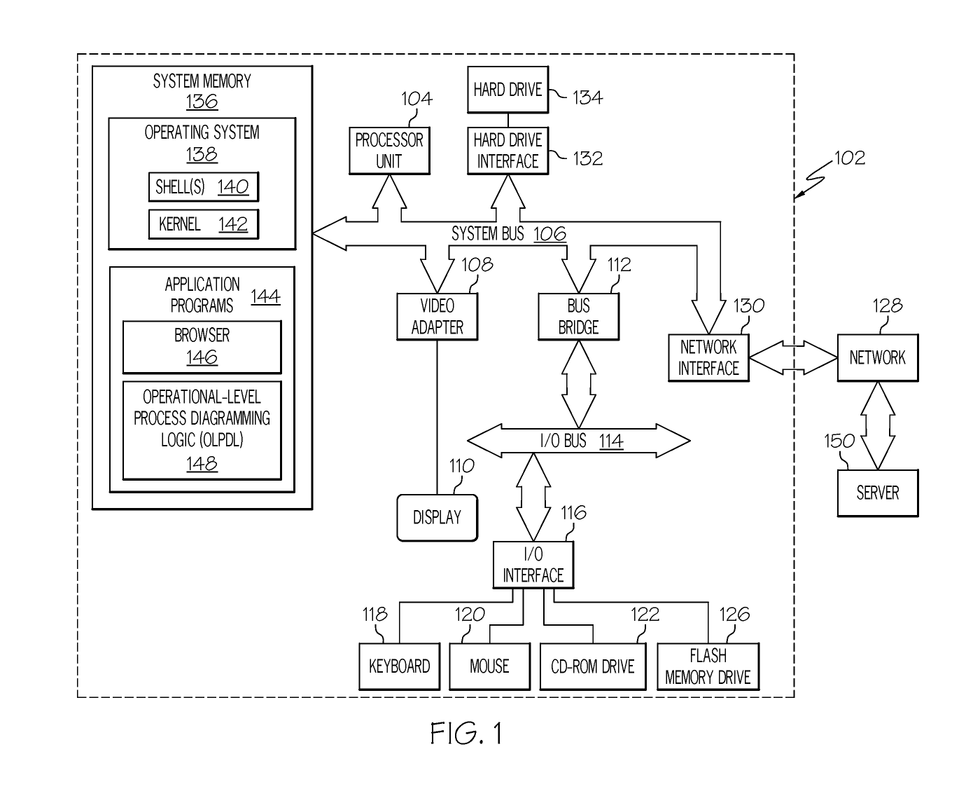

With reference now to FIG. 1, there is depicted a block diagram of an exemplary computer 102, in which the present invention may be utilized. Note that some or all of the exemplary architecture shown for computer 102 may be utilized by software deploying server 150.

Computer 102 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 116 may be any known to those skilled in the art of computer architecture, including but not limited to Universal Serial Bus (USB) ports.

Computer 102 is able to communicate with a software deploying server 150 via a network 128 using a network interface 130, which is coupled to system bus 106. Network 128 may be an external network such as the Internet, or an internal network such as an Ethernet or a Virtual Private Network (VPN). Note the software deploying server 150 may utilize a same or substantially similar architecture as computer 102. Likewise, Personal Digital Assistant (PDA) 802, server 804, Point of Sale (POS) station 806, and/or wireless station 808 shown in FIG. 8 may utilize a same or substantially similar architecture as computer 102.

A hard drive interface 132 is also coupled to system bus 106. Hard drive interface 132 interfaces with a hard drive 134. In a preferred embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (also called a command processor) is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a browser 146. Browser 146 includes program modules and instructions enabling a World Wide Web (WWW) client (i.e., computer 102) to send and receive network messages to the Internet using HyperText Transfer Protocol (HTTP) messaging, thus enabling communication with software deploying server 150.

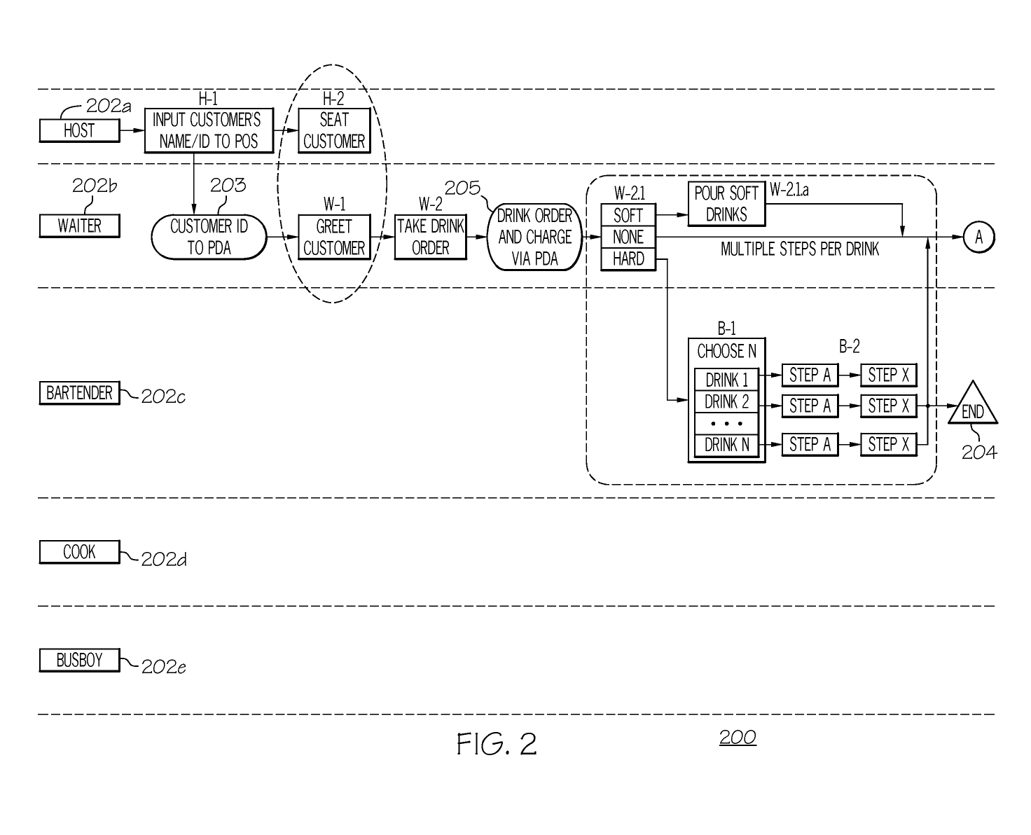

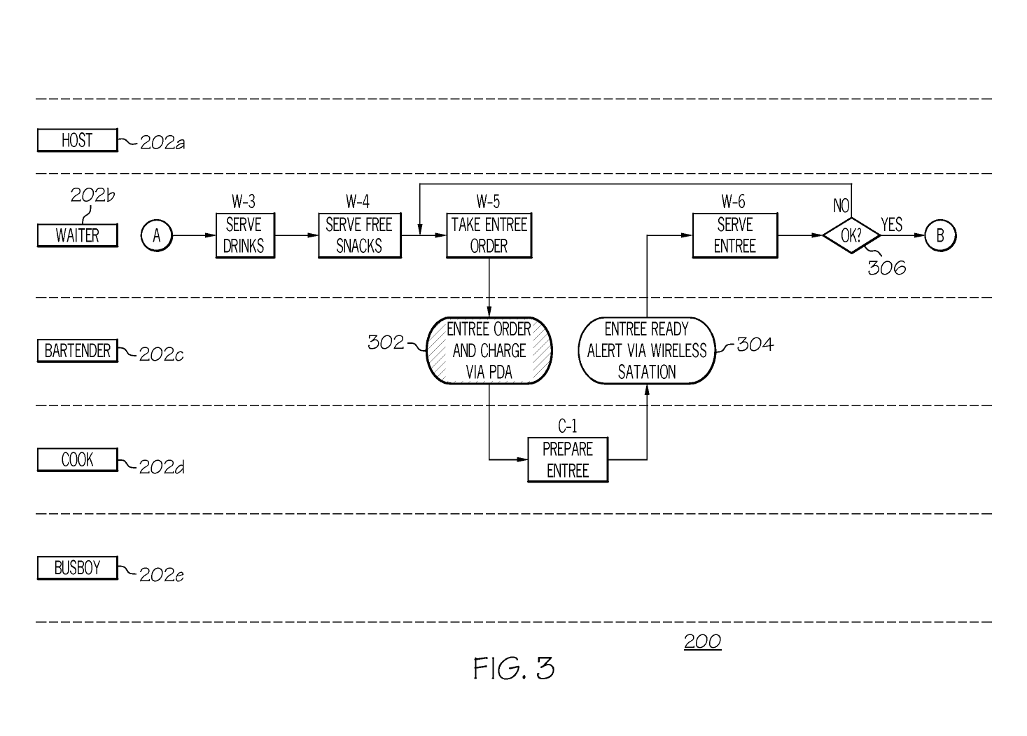

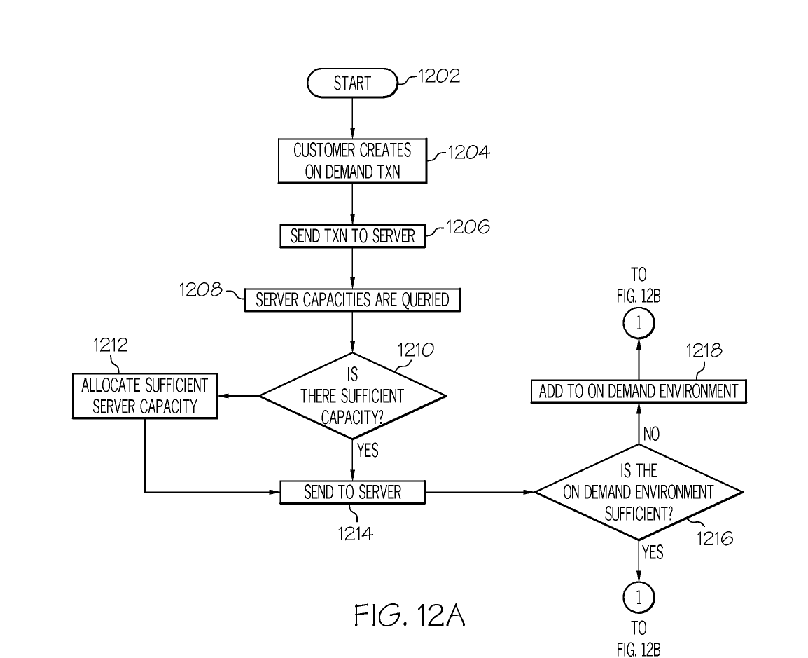

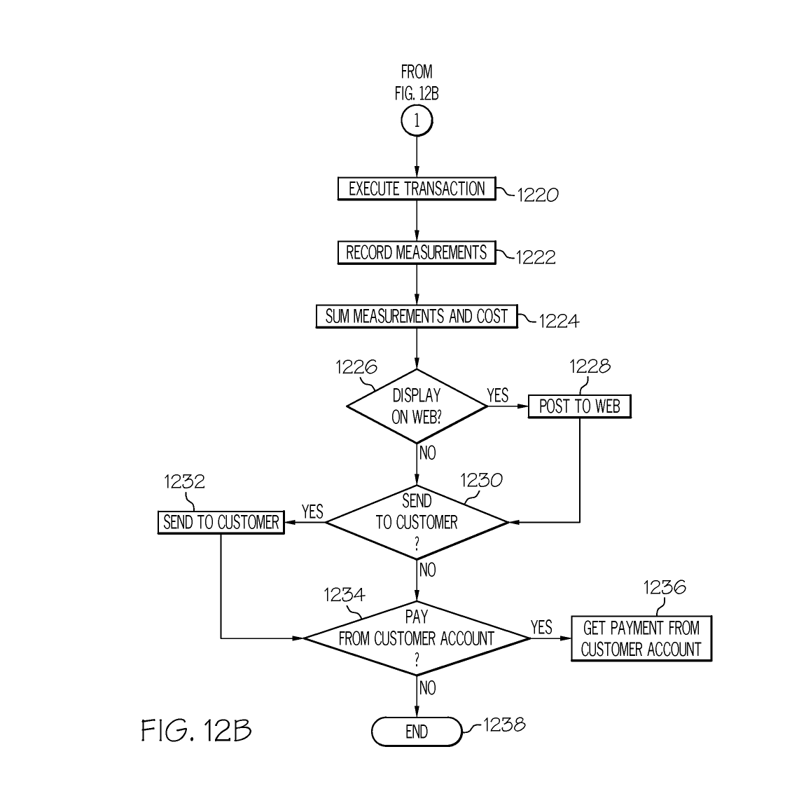

Application programs 144 in computer 102's system memory (as well as software deploying server 150's system memory) also include an Operational-Level Process Diagramming Logic (OLPDL) 148. OLPDL 148 includes code for implementing the processes described in FIGS. 2-11B. In one embodiment, computer 102 is able to download OLPDL 148 from software deploying server 150, including in an “on demand” basis, as described in greater detail below in FIGS. 11a-12B.

The hardware elements depicted in computer 102 are not intended to be exhaustive, but rather are representative to highlight essential components required by the present invention. For instance, computer 100 may include alternate memory storage devices such as magnetic cassettes, Digital Versatile Disks (DVDs), Bernoulli cartridges, and the like. These and other variations are intended to be within the spirit and scope of the present invention.

Note further that, in a preferred embodiment of the present invention, software deploying server 150 performs all of the functions associated with the present invention (including execution of OLPDL 148), thus freeing computer 102 from having to use its own internal computing resources to execute OLPDL 148.

With reference now to FIGS. 2-5, an exemplary operational-level process diagram 200 is presented. Operational-level process diagram 200 provides a depiction and display of a business process on a process diagram. The business process is a manifestation of an enterprise objective, and comprises multiple steps that are performed by one or more actors to meet the enterprise objective. Thus, the process diagram illustrates a step depiction of each of the multiple steps that are performed by the actor(s). While the operational-level process diagram 200 may be constructed for any business process and enterprise objective, for exemplary purposes, assume that the business process is a description of steps taken to run a restaurant (enterprise objective). The operational-level process diagram 200 thus is made up of multiple swim-lanes (delineated by bold horizontal dashed lines), each of which is dedicated to a different actor 102a-e. An exemplary process is as follows.

First, a host 202a will greet a new customer, and will input that customer's name (or other identification) into a Point Of Sale (POS) terminal (step H-1). The customer's ID is transmitted from the POS terminal (e.g., via an intermediate wireless server) to a Personal Digital Assistant (PDA) or other wireless device utilized by a waiter 202b. The host 202a then shows the customer to her table (step H-2), while the waiter 202b contemporaneously greets the customer (step W-1). Thus, step H-2 and step W-1 are synchronized activities, which occur simultaneously. The waiter 202b then takes the customer's drink order (step W-2). Drink data (the drink order and the charge associated with that drink order) is entered into the waiter's PDA, for transmission to a main server and a wireless station located at the bar. That is, the order data (W-2.1) indicates what soft and/or hard drinks have been ordered, if any, and also includes a running total of charges for soft and hard drinks that have been ordered. The waiter 202b will obtain the soft drinks (step W.2.1.a) while the bartender 202c chooses a recipe for an ordered hard drink (step B-1). The bartender 202c then follows these recipe(s) to create the hard drinks (step B-2). Note that step W.2.1.a and steps B-1 and B-2 are collaborative steps, since they are both performed to perform the consolidated (collaborative) step of preparing drinks (both alcoholic (hard) and non-alcoholic (soft)). After step B-2, the steps to be performed by the bartender 202c for this customer are completed (terminator 204).

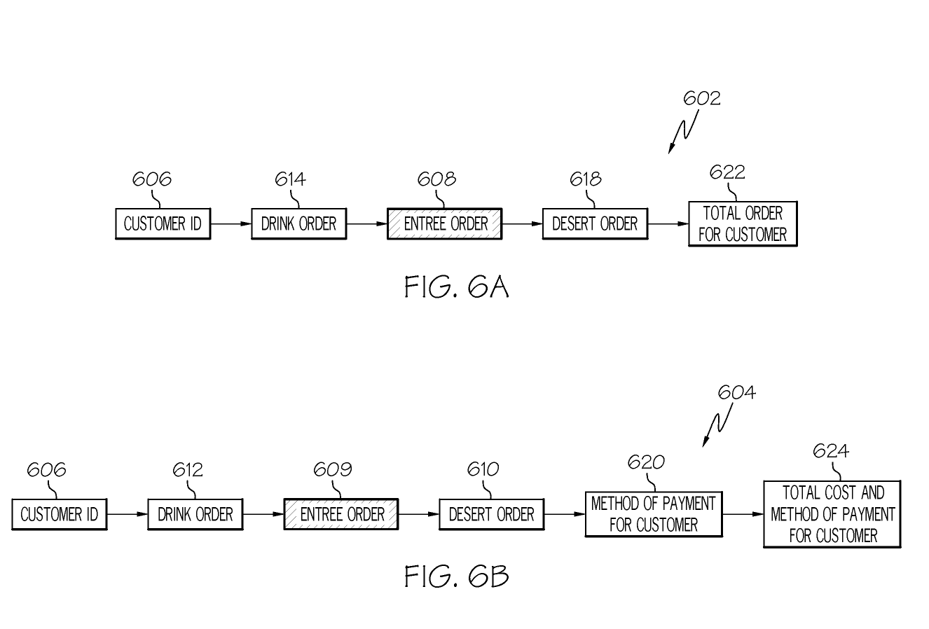

Continuing the process in FIG. 3, the waiter 202b then serves both the soft and hard drinks (step W-3) and serves any free snacks (step W-4). The waiter 202b then takes the customer's entrée order (step W-5). In one embodiment, the order is again entered into a PDA held by the waiter 202b, and includes both the order description as well as the order charge. The order description is transmitted to a wireless station in the kitchen, while the order price is transmitted to a server. In order for a user to be able to understand all of the information underlying that depicted in link 302, assume that operational-level process diagram 200 is depicted on a computer display (such as display 110 shown in FIG. 1). By clicking link 302 (e.g., with a device such as mouse 120 shown in FIG. 1), information such as organization charts, data flows, data models, system diagrams, etc., may be pulled up. Thus, link 302 may function as an exemplary data flow display link, data model display link, technology display link, and/or organization chart link. For example, clicking link 302 (causing it to act as a data flow display link) may pull up data flows 602 and/or 604 shown in FIGS. 6A-B.

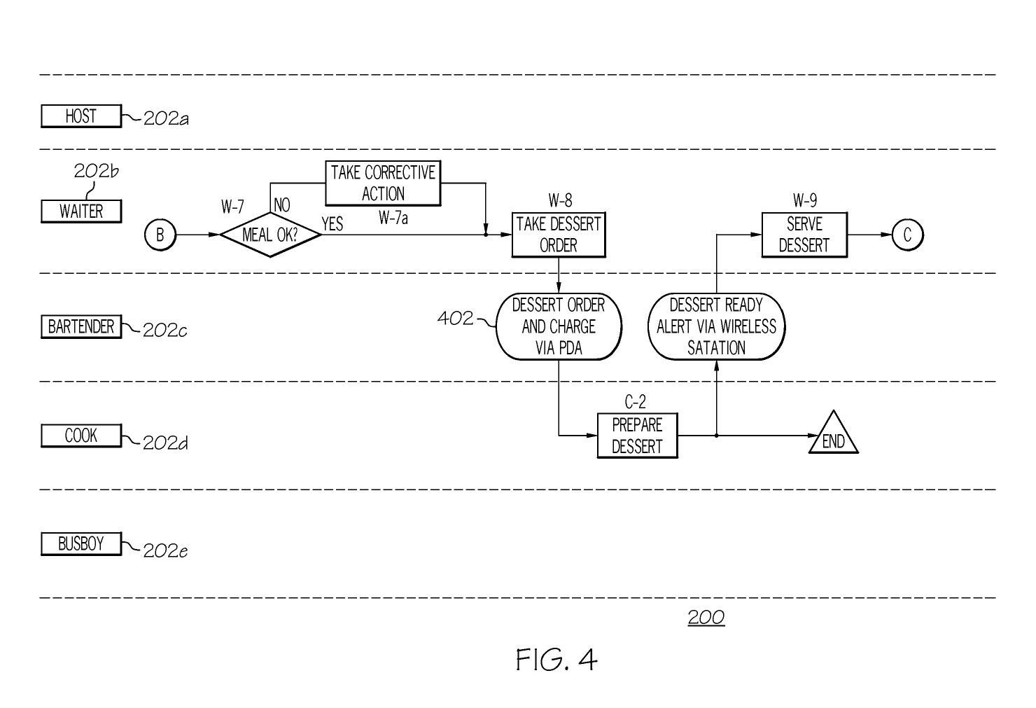

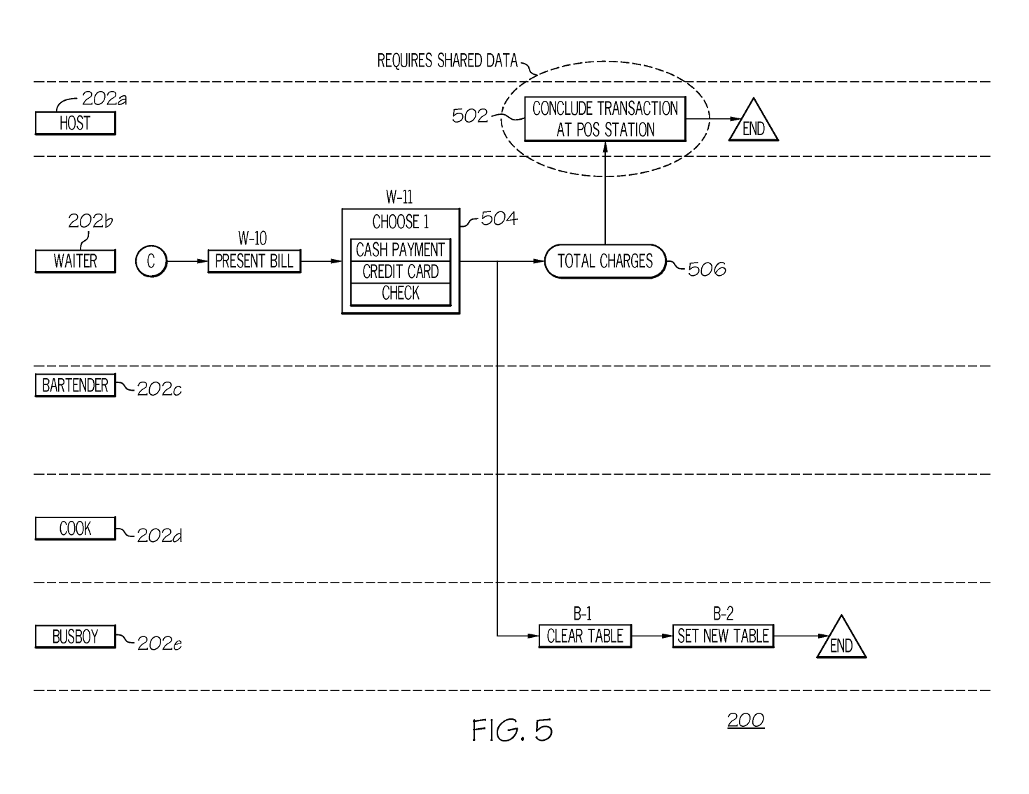

With reference to FIG. 6A, data flow 602 represents a data flow for how orders are collected for a particular customer (identified by a customer ID 606). In the example of the operational-level process diagram 200 shown in FIGS. 2-5, the data flow 602 for the food order includes obtaining the customer's ID 606 (corresponding to data 203 shown in FIG. 2), the drink order 614 (corresponding with the data 205 shown in FIG. 2), the entrée order 608 (corresponding with data from data link 302 in FIG. 3), the dessert order 618 (corresponding with data 402 shown in FIG. 4), which all lead to a total order 622 (corresponding with data 506 shown in FIG. 5) for the particular customer identified by customer ID 606. Similarly, clicking link 302 in FIG. 3 may result in the manifestation of data flow 604, which is the data flow for restaurant charges incurred by the particular customer identified by customer ID 606, and includes the customer's ID 606, drink costs 612 (corresponding with data 205 shown in FIG. 2), entrée cost 609 (corresponding with data from data link 302 in FIG. 3), dessert cost 610 (corresponding with data 402 in FIG. 4), the method of payment 620 (corresponding with data shown in block 504 in FIG. 5), and the total cost and method of payment 624 (corresponding with data from block 502 in FIG. 5) for that particular customer. Note that blocks 608 and 609 are both shaded and highlighted, indicating that the data shown in the boxes has been extracted from link 302, thus showing where in the data flows 602 and 604 the data from link 302 is oriented. That is, data flows 602 and 604 not only show that data from link 302 is part of these data flows, but also where in these data flows the data associated with link 302 (and its related operation) is positioned within the operational-level process diagram 200. By clicking link 302, a user is thus able to know that additional data has been and will be generated by the process represented by the operational-level process diagram 200.

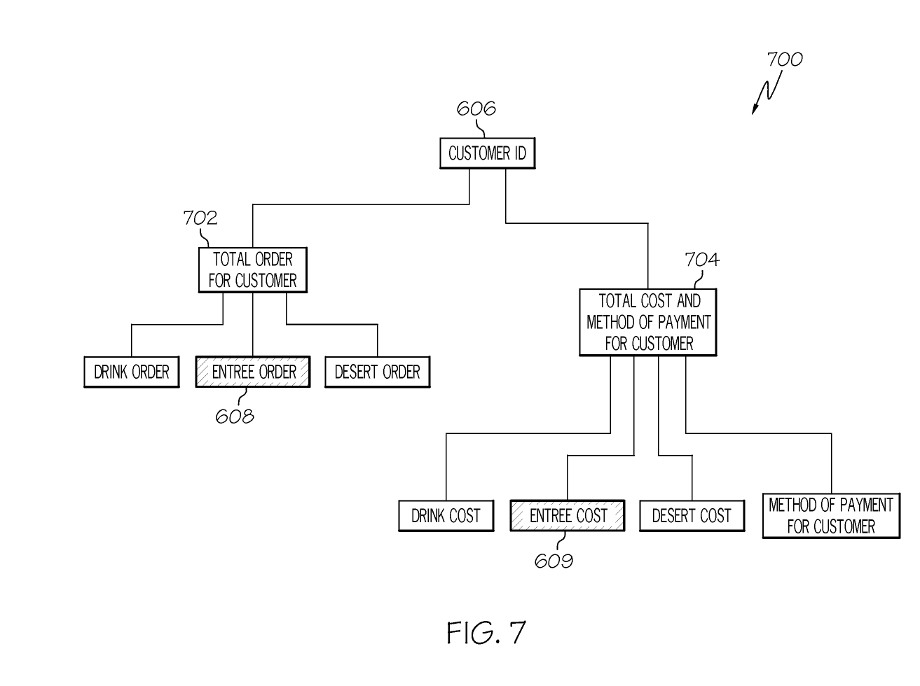

Similarly, clicking link 302 may result in a manifestation of data model 700, shown in FIG. 7. Data model 700 has similar components and manifestation appearances (e.g., shading, bolding to show the association with link 302) as data flows 602 and 604, but is organized in a hierarchical manner. Thus, entrée order 608 is dependent on the total order for the customer (block 702), and entrée cost 609 is dependent on the total cost and method of payment for the customer (block 704).

In addition, clicking link 302 may also result in a manifestation of what computer resources are being used at that point in the process. As manifested by system diagram 800 in FIG. 8 when link 302 is clicked, highlighting of PDA 802, server 804 and wireless station 806 (but not POS station 808) indicates that the PDA 802 is used (to enter the entree order and charge) at the point in the process represented by the positioning of link 302, server 804 is used (to store the entree order and cost) at that point, and wireless station 806 is used (to receive the entree order in the kitchen) at that point. Note, however, that the POS station 808 is not highlighted, since POS station 808 has no role at this point in the process.

Returning now to FIG. 3 and the process represented by operational-level process diagram 200, the cook 202d now prepares the entree (block C-1), and sends an alert from the wireless station in the kitchen to the waiter's PDA (data block 304). The waiter then serves the entree (block W-6). If there is a problem with the meal (query block 306), then the order is re-taken (block W-5). Otherwise, the process continues.

Continuing with the process now in FIG. 4, the operational-level process diagram 200 continues with a confirmation that the entire meal is satisfactory for the customer (query block W-7). If not, the waiter 202b takes corrective action (block W-7a). Otherwise, the waiter 202b takes the dessert order (block W-8), and sends this order to the kitchen (from his PDA to the cook's wireless station), where the cook 202d prepares the dessert (block C-2). The cook 202d alerts the waiter's PDA (using her wireless station in the kitchen) that the dessert is ready, and the waiter 202b then serves the desert (block W-9).

Continuing with the process now in FIG. 5, the operational-level process diagram 200 continues with the waiter 202b presenting the bill (block W-10) to the customer, who then chooses a method of payment (block W-11). The charges are totaled up and sent to the host, who concludes the transaction at his POS station (block 502). Note that the process described by block 502 (and performed at the POS terminal 808 in FIG. 8 by the host 202a) requires shared data received from the waiter's PDA (e.g., PDA 802 shown in FIG. 8) and the restaurant's computer server (e.g., server 804 shown in FIG. 8), in order to show the description of the food and drink items order (from the PDA), as well as the charges (including tip, tax, etc.) calculated by the server. The busboy 202e is now able to clear (block B-1) and set the table (block B-2), thus concluding the process depicted by the operational-level process diagram 200 for a particular diner/customer.

Note that any step and/or data block shown in operational-level process diagram 200 may be an active link, which pulls up (manifests) the data flows, data model, organization chart, and/or system diagram relevant to that point in the process flow, in a manner described above.

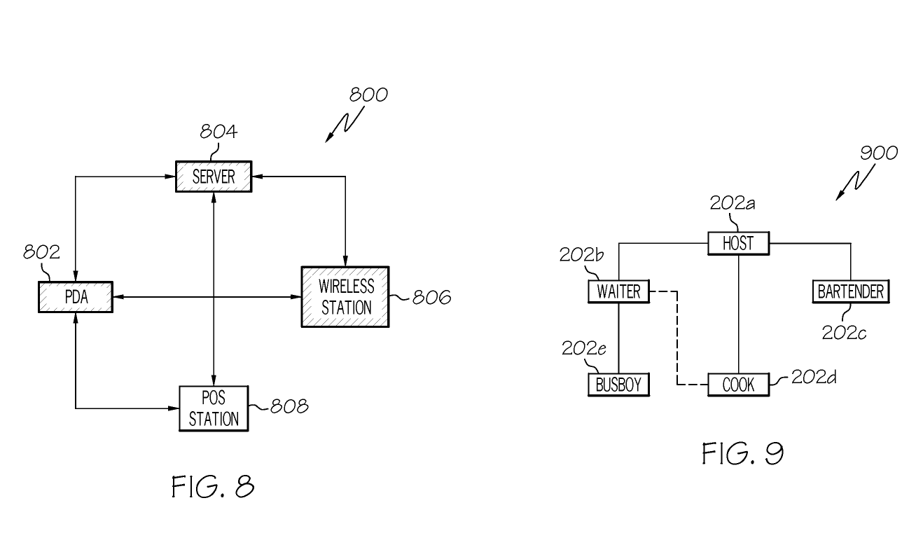

With reference now to FIG. 9, a preliminary organization chart 900 showing actors represented in operational-level process diagram 200 is presented. In one embodiment, operational-level process diagram 200 may be used to dynamically alter this organization chart 900. For example, operational-level process diagram 200 may be used to determine which actors directly pass data between themselves. In the example shown in FIG. 3, waiter 202b and cook 202d have direct interaction, including passing of data (e.g., entrée orders) between them. Therefore, the operational-level process diagram 200 may cause an automatic modification of the organization chart 900 to break the relationship between the host 202a and the cook 202d, and causing the waiter 202b to be directly linked to (and perhaps having authority over) the cook 202d.

In another embodiment, merely clicking one of the actor boxes (e.g., one of boxes 202a-e shown in FIG. 2) can result in the manifestation of the organization chart 900, thus showing where in the organization chart a particular actor is located.

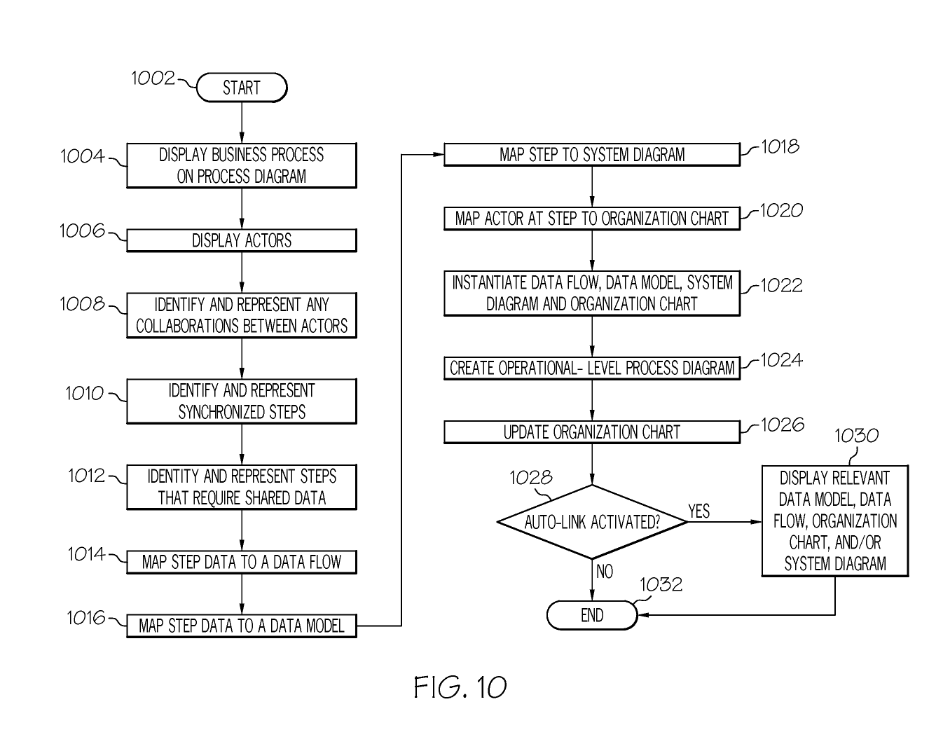

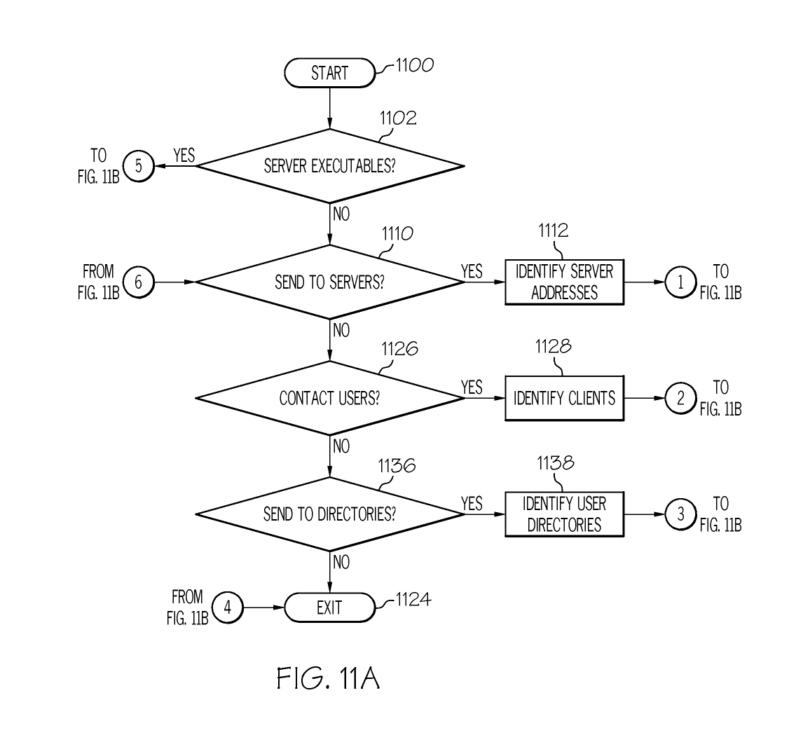

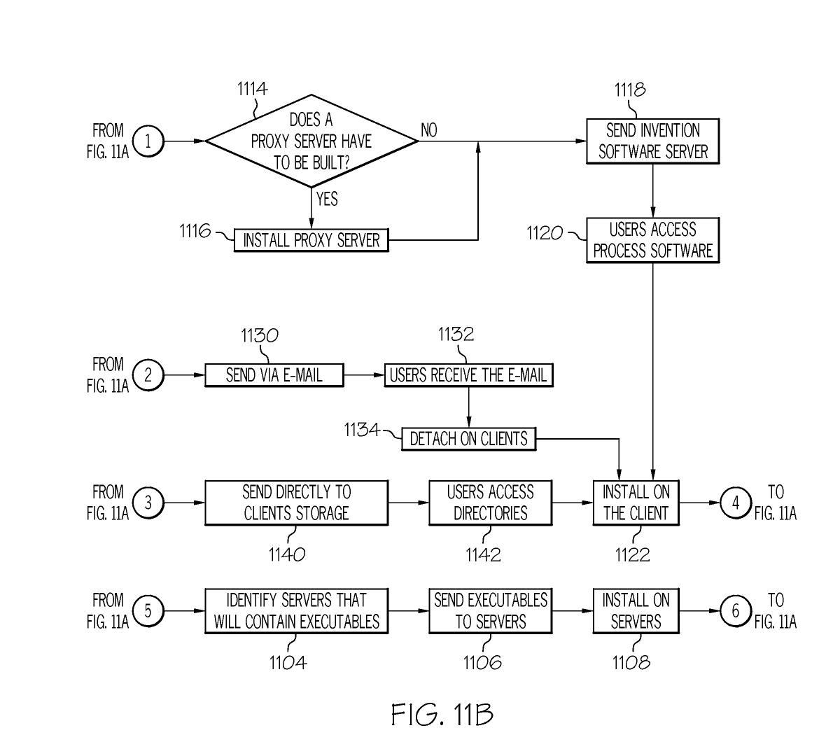

With reference now to FIG. 10, a high-level flow-chart of exemplary steps taken to create and utilize an operational-level process diagram is presented. After initiator block 1002, a business process is displayed on a process diagram (block 1004). This business process is a manifestation of an enterprise objective. The business process includes multiple steps performed by one or more actors to meet the enterprise objective. The process diagram illustrates a step depiction for each of the multiple steps by one or more of the actors, which are displayed on the process diagram (block 1006). Any collaboration between actors is identified and represented on the process diagram (block 1008), as are any synchronized steps (block 1010) or steps that require shared data (block 1012). Each block (step depiction and/or data depiction) is mapped to a data flow (block 1014) and a data model (block 1016). The hardware and/or software (technology requirements obtained from a system represented by a system diagram) used by each step in the process is also mapped to the step depictions (block 1018). Each of the actors in the process is mapped to an enterprise organization chart (block 1020). With all information identified, represented, and mapped, instantiated and synchronized (block 1022), the operational-level process diagram is now created from the original inert process diagram (block 1024). If appropriate (based on data passing between actors), the organization chart can be automatically updated (block 1026). Thereafter, whenever a user clicks an active link on the operational-level process diagram (block 1028), the appropriate data model, data flow, organization chart, and/or system diagram is displayed (block 1030), and the process ends (terminator block 1032). Note that which of the data model, data flow, organization chart or system diagram is to be displayed may be manually chosen by the user (using a pull-down menu, pop-up window, etc.), or it may be intelligently determined by the system according to previous selections by the user, positioning of the active link in the operational-level process diagram, etc.

It should be understood that at least some aspects of the present invention may alternatively be implemented in a computer-readable medium that contains a program product. Programs defining functions of the present invention can be delivered to a data storage system or a computer system via a variety of tangible signal-bearing media, which include, without limitation, non-writable storage media (e.g., CD-ROM), writable storage media (e.g., hard disk drive, read/write CD ROM, optical media), as well as non-tangible communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

### Software Deployment

As described above, in one embodiment, the processes described by the present invention, including the functions of OLPDL 148, are performed by service provider server 150. Alternatively, OLPDL 148 and the method described herein, and in particular as shown and described in FIGS. 2-10, can be deployed as a process software from service provider server 150 to computer 100. Still more particularly, process software for the method so described may be deployed to service provider server 150 by another service provider server (not shown).

Referring then to FIGS. 11A-B, step 1100 begins the deployment of the process software. The first thing is to determine if there are any programs that will reside on a server or servers when the process software is executed (query block 1102). If this is the case, then the servers that will contain the executables are identified (block 1104). The process software for the server or servers is transferred directly to the servers' storage via File Transfer Protocol (FTP) or some other protocol or by copying though the use of a shared file system (block 1106). The process software is then installed on the servers (block 1108).

Next, a determination is made on whether the process software is to be deployed by having users access the process software on a server or servers (query block 1110). If the users are to access the process software on servers, then the server addresses that will store the process software are identified (block 1112).

A determination is made if a proxy server is to be built (query block 1114) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (block 1116). The process software is sent to the servers either via a protocol such as FTP or it is copied directly from the source files to the server files via file sharing (block 1118). Another embodiment would be to send a transaction to the servers that contained the process software and have the server process the transaction, then receive and copy the process software to the server's file system. Once the process software is stored at the servers, the users, via their client computers, then access the process software on the servers and copy to their client computers file systems (block 1120). Another embodiment is to have the servers automatically copy the process software to each client and then run the installation program for the process software at each client computer. The user executes the program that installs the process software on his client computer (block 1122) then exits the process (terminator block 1124).

In query step 1126, a determination is made whether the process software is to be deployed by sending the process software to users via e-mail. The set of users where the process software will be deployed are identified together with the addresses of the user client computers (block 1128). The process software is sent via e-mail to each of the users' client computers (block 1130). The users then receive the e-mail (block 1132) and then detach the process software from the e-mail to a directory on their client computers (block 1134). The user executes the program that installs the process software on his client computer (block 1122) then exits the process (terminator block 1124).

Lastly a determination is made as to whether the process software will be sent directly to user directories on their client computers (query block 1136). If so, the user directories are identified (block 1138). The process software is transferred directly to the user's client computer directory (block 1140). This can be done in several ways such as but not limited to sharing of the file system directories and then copying from the sender's file system to the recipient user's file system or alternatively using a transfer protocol such as File Transfer Protocol (FTP). The users access the directories on their client file systems in preparation for installing the process software (block 1142). The user executes the program that installs the process software on his client computer (block 1122) and then exits the process (terminator block 1124).

### VPN Deployment

The present software can be deployed to third parties as part of a service wherein a third party VPN service is offered as a secure deployment vehicle or wherein a VPN is build on-demand as required for a specific deployment.

A virtual private network (VPN) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-free number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a company's multiple fixed sites over a public network such as the Internet.

The process software is transported over the VPN via tunneling which is the process of placing an entire packet within another packet and sending it over a network. The protocol of the outer packet is understood by the network and both points, called tunnel interfaces, where the packet enters and exits the network.

### Software Integration

The process software which consists of code for implementing the process described herein may be integrated into a client, server and network environment by providing for the process software to coexist with applications, operating systems and network operating systems software and then installing the process software on the clients and servers in the environment where the process software will function.

The first step is to identify any software on the clients and servers, including the network operating system where the process software will be deployed, that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists match the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

### On Demand

The process software is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the accessed server may make requests of other servers that require CPU units. CPU units describe an example that represents but one measurement of use. Other measurements of use include but are not limited to network bandwidth, memory utilization, storage utilization, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory utilization, storage utilization, etc. approach a capacity so as to affect performance, additional network bandwidth, memory utilization, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and/or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

With reference now to FIGS. 12a-b, initiator block 1202 begins the On Demand process. A transaction is created than contains the unique customer identification, the requested service type and any service parameters that further specify the type of service (block 1204). The transaction is then sent to the main server (block 1206). In an On Demand environment the main server can initially be the only server, then as capacity is consumed other servers are added to the On Demand environment.

The server central processing unit (CPU) capacities in the On Demand environment are queried (block 1208). The CPU requirement of the transaction is estimated, then the server's available CPU capacity in the On Demand environment are compared to the transaction CPU requirement to see if there is sufficient CPU available capacity in any server to process the transaction (query block 1210). If there is not sufficient server CPU available capacity, then additional server CPU capacity is allocated to process the transaction (block 1212). If there was already sufficient available CPU capacity then the transaction is sent to a selected server (block 1214).

Before executing the transaction, a check is made of the remaining On Demand environment to determine if the environment has sufficient available capacity for processing the transaction. This environment capacity consists of such things as but not limited to network bandwidth, processor memory, storage etc. (block 1216). If there is not sufficient available capacity, then capacity will be added to the On Demand environment (block 1218). Next the required software to process the transaction is accessed, loaded into memory, then the transaction is executed (block 1220).

The usage measurements are recorded (block 1222). The utilization measurements consist of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer (block 1224).

If the customer has requested that the On Demand costs be posted to a web site (query block 1226), then they are posted (block 1228). If the customer has requested that the On Demand costs be sent via e-mail to a customer address (query block 1230), then these costs are sent to the customer (block 1232). If the customer has requested that the On Demand costs be paid directly from a customer account (query block 1234), then payment is received directly from the customer account (block 1236). The On Demand process is then exited at terminator block 1238.

Operational Transformation unifies key elements of a process: people, process, and technology. It both enforces and correctly limits the expanses of IT and organization elements based on what the operational process design requires. It limits any process analysis to the basis of the process (data, steps, roles, tools, measurements). This naturally expands the process definition to be end-to-end, which causes the consolidation and elimination of redundant organizational and technology requirements. It expands because the Business Transformation requirements are dictated by the process.

As utilized herein, a process is an organized group of related activities that works together to create customer value. Operational process descriptions are unique in that they are the intersect point of the main elements of the business architecture: business process linkage, technology support, and organizational execution. Representation of this intersection is called the operational view.

An operational level process diagram described herein depicts the execution linkage between process, organization and technology at the operational level. As a result, business objectives, issues, and requirements can be effectively linked to technology and organization through critical process elements. This perspective ensures effective transformation of process, organization (role changes, job design, performance measures, etc.), and technology (requirements, multiple package implications, application integration, business process inter-linkage, scenario validation, etc.).

The operational transformation afforded by the operational-level process diagram described herein unifies key elements of a process: people, process, and technology. The operational transformation both enforces and correctly limits the expanses of Information Technology (IT) and organization elements based on what the operational process design requires. It limits any process analysis to the basis of the process (data, steps, roles, tools, measurements). This naturally expands the process definition to be end-to-end, which causes the consolidation and elimination of redundant organizational and technology requirements.

While the present invention has been particularly shown and described with reference to a preferred embodiment, it will be understood by those skilled in the art that various changes in form and detail may be made therein without departing from the spirit and scope of the invention. For example, while the present description has been directed to a preferred embodiment in which custom software applications are developed, the invention disclosed herein is equally applicable to the development and modification of application software. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A method of analyzing business processes, comprising the steps of:
displaying a business process on a process diagram, wherein the business process is a manifestation of an enterprise objective, wherein the business process comprises multiple steps performed by one or more actors to meet the enterprise objective, and wherein the process diagram illustrates a step depiction of each of the multiple steps performed by one or more of the actors;
displaying multiple actor representations in a swim lane of the process diagram;
identifying and representing, on the process diagram, any collaboration steps between multiple actors in the business process;
identifying and representing, on the process diagram, multiple steps that require synchronized execution by multiple actors in the business process;
identifying and representing, on the process diagram, any steps in the business process that require shared data;
mapping data between a data flow and one or more step depictions in the process diagram;
mapping data between a data model and one or more of the step depictions in the process diagram;
mapping technology requirements between a system diagram and one or more of the step depictions in the process diagram;
mapping each of the actors from the process diagram onto an enterprise organization chart;
instantiating the data flow, data model, system diagram and enterprise organization chart in the process diagram; and
synchronizing the enterprise objectives, the technology requirements, collaborations, synchronized execution, data flow, data model, and enterprise organization chart to create an operational-level process diagram from the process diagram.

2. The method of claim 1, further comprising:
identifying two actors, represented in the operational-level process diagram, who directly pass data between the two actors; and
automatically modifying the organization chart to directly link a representation of the two actors in the organization chart.

3. The method of claim 1, further comprising:
creating an organization display link between an actor representation and the organization chart, wherein activating the organization display link at actor representation automatically displays the position of a represented actor in the organization chart.

4. The method of claim 1, further comprising:
creating a data flow display link between particular data represented at a particular step depiction and the data flow, wherein activating the data flow display link at the particular step automatically displays the position of the particular data in the data flow.

5. The method of claim 1, further comprising:
creating a data model display link between particular data represented at a particular step depiction and the data model, wherein activating the data model display link at the particular step automatically displays the position of the particular data in the data model.

6. The method of claim 1, further comprising:
creating a technology display link between a particular step depiction and the system diagram, wherein activating the technology display link automatically displays a resource, in the system diagram, that is required for a particular step being depicted by the particular step depiction.

7. A system comprising:
a processor;
a data bus coupled to the processor;
a memory coupled to the data bus; and
a computer-usable medium embodying computer program code, the computer program code comprising instructions executable by the processor and configured for analyzing business processes by performing the steps of:
displaying a business process on a process diagram, wherein the business process is a manifestation of an enterprise objective, wherein the business process comprises multiple steps performed by one or more actors to meet the enterprise objective, and wherein the process diagram illustrates a step depiction of each of the multiple steps performed by one or more of the actors;
displaying multiple actor representations in a swim lane of the process diagram;
identifying and representing, on the process diagram, any collaboration steps between multiple actors in the business process;
identifying and representing, on the process diagram, multiple steps that require synchronized execution by multiple actors in the business process;
identifying and representing, on the process diagram, any steps in the business process that require shared data;
mapping data between a data flow and one or more step depictions in the process diagram;
mapping data between a data model and one or more of the step depictions in the process diagram;
mapping technology requirements between a system diagram and one or more of the step depictions in the process diagram;
mapping each of the actors from the process diagram onto an enterprise organization chart;
instantiating the data flow, data model, system diagram and enterprise organization chart in the process diagram; and
synchronizing the enterprise objectives, the technology requirements, collaborations, synchronized execution, data flow, data model, and enterprise organization chart to create an operational-level process diagram from the process diagram.

8. The system of claim 7, wherein the instructions are further configured for:
identifying two actors, represented in the operational-level process diagram, who directly pass data between the two actors; and
automatically modifying the organization chart to directly link a representation of the two actors in the organization chart.

9. The system of claim 7, wherein the instructions are further configured for:
creating an organization display link between an actor representation and the organization chart, wherein activating the organization display link at actor representation automatically displays the position of a represented actor in the organization chart.

10. The system of claim 7, wherein the instructions are further configured for:
creating a data flow display link between particular data represented at a particular step depiction and the data flow, wherein activating the data flow display link at the particular step automatically displays the position of the particular data in the data flow.

11. The system of claim 7, wherein the instructions are further configured for:
creating a data model display link between particular data represented at a particular step depiction and the data model, wherein activating the data model display link at the particular step automatically displays the position of the particular data in the data model.

12. The system of claim 7, wherein the instructions are further configured for:
creating a technology display link between a particular step depiction and the system diagram, wherein activating the technology display link automatically displays a resource, in the system diagram, that is required for a particular step being depicted by the particular step depiction.

13. A computer-readable medium encoded with a computer program, the computer program comprising computer executable instructions configured for:
displaying a business process on a process diagram, wherein the business process is a manifestation of an enterprise objective, wherein the business process comprises multiple steps performed by one or more actors to meet the enterprise objective, and wherein the process diagram illustrates a step depiction of each of the multiple steps performed by one or more of the actors;
displaying multiple actor representations in a swim lane of the process diagram;
identifying and representing, on the process diagram, any collaboration steps between multiple actors in the business process;
identifying and representing, on the process diagram, multiple steps that require synchronized execution by multiple actors in the business process;
identifying and representing, on the process diagram, any steps in the business process that require shared data;
mapping data between a data flow and one or more step depictions in the process diagram;
mapping data between a data model and one or more of the step depictions in the process diagram;
mapping technology requirements between a system diagram and one or more of the step depictions in the process diagram;
mapping each of the actors from the process diagram onto an enterprise organization chart;
instantiating the data flow, data model, system diagram and enterprise organization chart in the process diagram; and
synchronizing the enterprise objectives, the technology requirements, collaborations, synchronized execution, data flow, data model, and enterprise organization chart to create an operational-level process diagram from the process diagram.

14. The computer-readable medium of claim 13, wherein the instructions are further configured for:
identifying two actors, represented in the operational-level process diagram, who directly pass data between the two actors; and
automatically modifying the organization chart to directly link a representation of the two actors in the organization chart.

15. The computer-readable medium of claim 13, wherein the instructions are further configured for:
creating an organization display link between an actor representation and the organization chart, wherein activating the organization display link at actor representation automatically displays the position of a represented actor in the organization chart.

16. The computer-readable medium of claim 13, wherein the instructions are further configured for:
creating a data flow display link between particular data represented at a particular step depiction and the data flow, wherein activating the data flow display link at the particular step automatically displays the position of the particular data in the data flow.

17. The computer-readable medium of claim 13, wherein the instructions are further configured for:
creating a data model display link between particular data represented at a particular step depiction and the data model, wherein activating the data model display link at the particular step automatically displays the position of the particular data in the data model.

18. The computer-readable medium of claim 13, wherein the instructions are further configured for:
creating a technology display link between a particular step depiction and the system diagram, wherein activating the technology display link automatically displays a resource, in the system diagram, that is required for a particular step being depicted by the particular step depiction.

19. The computer-readable medium of claim 13, wherein the computer-readable medium is a component of a remote server, and wherein the computer executable instructions are deployable to a supervisory computer from the remote server.

20. The computer-readable medium of claim 13, wherein the computer executable instructions are capable of being provided by a service provider to a customer on an on-demand basis.
